(19) United States
(12) Patent Application Publication
(10) Pub. No.: US 2007/0285393 A1
(43) Pub. Date: Dec. 13, 2007

(54) Universal Multifunctional Key for Input/Output Devices

(76) Inventor: Mark Ishakov, Sderot (IL)

Correspondence Address: DARBY & DARBY P.C., P.O. BOX 770, Church Street Station, New York, NY, 10008-0770, US

(21) Appl. No.: 10/582,644

(22) PCT Filed:
(86) PCT No.: PCT/IL04/01131

Related U.S. Application Data
(60) Provisional application No. 60/529,718, filed on Dec. 15, 2003.

(51) Int. Cl. G09G 5/00

(52) U.S. Cl. 345/168

(57) ABSTRACT

The present invention, as shown in FIG. 2, provides multifunctional key (20) adapted to be used in input and output devices. The multifunctional key comprises a touch surface (22) and a display means (32) adjacent to the touch surface wherein the display means is adapted to changeably display signs. Keying in the multi-functional key generates an electronic signal corresponding to the sign currently displayed on the touch surface. The display means is preferably made LED matrix.

### FIELD OF THE INVENTION

The present invention is related to data input devices. More particularly, the present invention is related to a multifunctional keyboard for universal use with automatically convertable keypads.

### BACKGROUND OF THE INVENTION

Input devices such as computer keyboards are known in the art. Keyboards are adapted to convert electrical signals generated by key in a key representing a certain letter or number into a sign that appears on a monitor. There are also input devices having notations other than letters or numbers that are represented on the keys of a keyboard. Keyboards or keypads are a part of every computerized system exists nowadays.

One main disadvantage especially of personal computer keyboards today is that they are adapted for a certain language and there is a problem in converting the keyboard into another language. This consequences in another disadvantage in which buying a computer in one country and transferring it to another one in which the language in not the same, may impose a problem.

One available solution is by manually patching the second language letters along the main language on the keys of the keyboard. This solution is limited due to the size of the keys and amount of information one can provide on each key. Another solution is the Trafarat which is a plastic or paper transparent cover to the keyboard representing a language that is not represented on the keyboard. This solution is not a universal solution due to the variety of keyboards exists. Trafarats tend also to be erased after some time and is not durable.

There is a need to provide an input device that is an intrinsic multi-lingual keyboard and can be adapted to numerous languages without any substantial modification.

### SUMMARY OF THE INVENTION

It is an object of the present invention to provide a multifunctional key adapted to be incorporated in an input device such as a keyboard that supports unlimited number of glyphs for various languages and notations of natural and formal languages, icons and other symbolic signs.

It is an object of the present invention to provide a multifunctional keyboard that supports unlimited number of glyphs for various languages and notations of natural and formal languages, icons and other symbolic signs.

It is another object of the present invention to provide a multifunctional keyboard that is ensured with dynamic changing or switching of images on the surfaces of the keys depending on the state of the system that is supported by the keyboard.

There is provided in accordance with a preferred embodiment of the present invention a multifunctional key adapted to be used in an input/output device, the multifunctional key comprising:
a touch surface;
a display means provided adjacent to said touch surface wherein said display means is adapted to changeably display signs;

whereby keying in said multifunctional key generates an electronic signal corresponding to the sign currently displayed on said touch surface.

Furthermore, in accordance with another embodiment of the present invention, said touch surface is transparent.

Furthermore, in accordance with another embodiment of the present invention, said display means is a LED matrix provided beneath said touch surface which is transparent.

Furthermore, in accordance with another embodiment of the present invention, said indicator is housed in a housing that rests on a stem; and wherein said stem is adapted to move downwardly when the multifunctional key is keyed in and move upwardly when the multifunctional key is released.

Furthermore, in accordance with another embodiment of the present invention, said stem is moving upwardly by the force of an elastomeric pad that resides in the input/output device beneath the multifunctional key.

Furthermore, in accordance with another embodiment of the present invention, the multifunctional key further comprises:
PCB adapted for placing and interconnecting electronic components;
driver chip adapted to power said LED matrix;
connecting cable adapted to allow communication between the multifunctional key and the input/output device.

Furthermore, in accordance with another embodiment of the present invention, said key's PCB is adapted to communicate with a PCB of the input/output device through contact sensors that are provided in the input/output device.

Furthermore, in accordance with another embodiment of the present invention, said chip driver is in multiplex mode that outputs low voltage level to cathodes provided in said LED matrix, by turn.

Furthermore, in accordance with another embodiment of the present invention, said chip driver maintains an average current of about 2 mA.

Furthermore, in accordance with another embodiment of the present invention, said connecting cable is provided with 6 wires and wherein a first wire is VDD—chip power voltage; second wire is CLK—clock signal; third wire is DIN—input data and control bit; fourth wire is SW—input signal of normally open key contact; fifth wire is GND—common wire of power, data and second signal contact; and the sixth wire is DO—output data and control bit.

Furthermore, in accordance with another embodiment of the present invention, said LED matrix comprises 7 columns and 11 rows of LEDs.

Furthermore, in accordance with another embodiment of the present invention, said driver chip comprises: an 11-digit shift register adapted to receive input data in serial code; row drivers connected to anodes provided in rows in said LED matrix; control circuit adapted to permit current output from said row drivers; column driver adapted to select the column of said LED matrix using a 7-digit looped shift register.

In accordance with yet another embodiment of the present invention, a multifunctional keyboard adapted to be used in an input/output device comprising:
a plurality of multifunctional keys wherein each multifunctional key comprises a touch surface and a display means provided adjacent to said touch surface wherein said display means is adapted to changeably display signs;
key PCB adapted for placing and interconnecting electronic components;
elastomeric pad having a plurality of sensory contacts wherein said elastomeric pad is provided beneath said plurality of multifunctional keys and wherein said elastomeric pad is adapted to uphold said plurality of multifunctional keys in an upward position so as to prevent contact with said sensory contacts when the multifunctional key is in said upward position and to allow contact when one of said plurality of multifunctional keys is keyed in;
keyboard PCB adapted to receive commands from said key PCB;
driver chip adapted to power said display means;
At least two keys adapted to allow change of the signs indicated on said plurality of multifunctional keys;

whereby keying in one of said at least two keys converts the signs indicated on said plurality of multifunctional keys so that keying in one of said plurality of multifunctional keys generates an electronic signal corresponding to the sign currently displayed on said indicator that is being transferred by said Keyboard PCB to a device that is connected to the input/output device.

Furthermore, in accordance with another embodiment of the present invention, said indicator is a LED matrix.

Furthermore, in accordance with another embodiment of the present invention, a connecting cable connected said key PCT and said keyboard PCB, and wherein said connecting cable is provided with 6 wires and wherein a first wire is VDD—chip power voltage; second wire is CLK—clock signal; third wire is DIN—input data and control bit; fourth wire is SW—input signal of normally open key contact; fifth wire is GND—common wire of power, data and second signal contact; and the sixth wire is DO—output data and control bit.

Furthermore, in accordance with another embodiment of the present invention, said driver chip comprises: an 11-digit shift register adapted to receive input data in serial code; row drivers connected to anodes provided in rows in said LED matrix; control circuit adapted to permit current output from said row drivers; column driver adapted to select the column of said LED matrix using a 7-digit looped shift register.

Furthermore, in accordance with another embodiment of the present invention, the multifunctional keyboard further comprises at least one key that is adapted to transfer electronic signals through said keyboard PCB when keyed in.

Furthermore, in accordance with another embodiment of the present invention, said multifunctional keyboard acts as an input/output device to devices selected from a group comprising a computer, a mobile computer, hand computer, telephone devices, controllers, a remote control and other devices.

Furthermore, in accordance with another embodiment of the present invention, said multifunctional keyboard is connected to a computer based on an actuating system such as windows, OS2, LINUX, UNIX, SOLARIS, or DOS.

Additionally, in accordance with another embodiment of the present invention, said signs are selected from a group such as fonts, computer language signs, chemical structures, amino acids, DNA codes, pictures, music notes, or car parts.

### BRIEF DESCRITPION OF THE FIGURES

In order to better understand the present invention and appreciate its practical applications, the following Figures are attached and referenced herein. Like components are denoted by like reference numerals.

It should be noted that the figures are given as examples and preferred embodiments only and in no way limit the scope of the present invention as defined in the appending Description and Claims.

FIG. 1 illustrates a multi-lingual keyboard in accordance with a preferred embodiment of the present invention, at a predetermined appearance.

FIG. 2a illustrates an upper view of a key in a multi-lingual keyboard in accordance with a preferred embodiment of the present invention.

FIG. 2b illustrates a side view of the key shown in FIG. 1a.

FIG. 3 illustrating a circuit of a LED matrix in accordance with a preferred embodiment of the present invention.

FIG. 4 illustrates a schematic representation of chip driver components in relation to the LED matrix in accordance with a preferred embodiment of the present.

FIG. 5 illustrates time diagrams of data exchange between a controller and two exemplary units in accordance with a preferred embodiment of the present invention.

FIG. 6 illustrates a circuit of connections to a plurality of keys in accordance with a preferred embodiment of the present invention.

FIG. 7 illustrate schematic representation of a controller in accordance with a preferred embodiment of the present invention.

FIG. 8 illustrates a schematic representation of the structure of multiplex channel of a keyboard controller in accordance with a preferred embodiment of the present invention.

### DETAILED DESCRIPTION OF THE INVENTION

The present invention provides a new and unique input devices such as keyboard having keys on which computerized representation of signs is provided instead of the mechanically drawn or curved letters in the regular keyboard. Prior art keyboard has a fixed adhered, carved or otherwise represented sign on each of its keys. The computerized representation of the present invention is a convertable representation adapted to change in accordance with a simple and easy to carry on instruction. The new keyboard of the present invention is a keyboard that is not solely an input device transmitting signals to the computer's processor, but the keyboard is an input device that receives signals and commands from the processor it is attached to or from at least one key provided on the keyboard itself. The new multi-lingual keyboard is an input device that is controllable and is adapted to receive electronic signals, too.

Generally, a keyboard in accordance with a preferred embodiment of the present invention consists of its base portion and key units. Each key unit comprises a cover having a window on the upper side with a touch surface; a display means that is preferably a LED matrix indicator preferably with 7 columns and 11 rows that resides beneath the window; key's PCB for placing and interconnecting electronic components; LED matrix driver chip; capacitor for the power circuit; and flexible connector cable. Plurality of such keys are provided on a keyboard base that comprises a body; PCB with contact sensors for the keys, electronic components for controlling the keyboard, its power and interconnections; elastomer pad for keys functioning; and optionally, a decorative front panel of the keyboard. A prototype was built in accordance with a preferred aspect of the present invention and is illustrated in the following explanation.

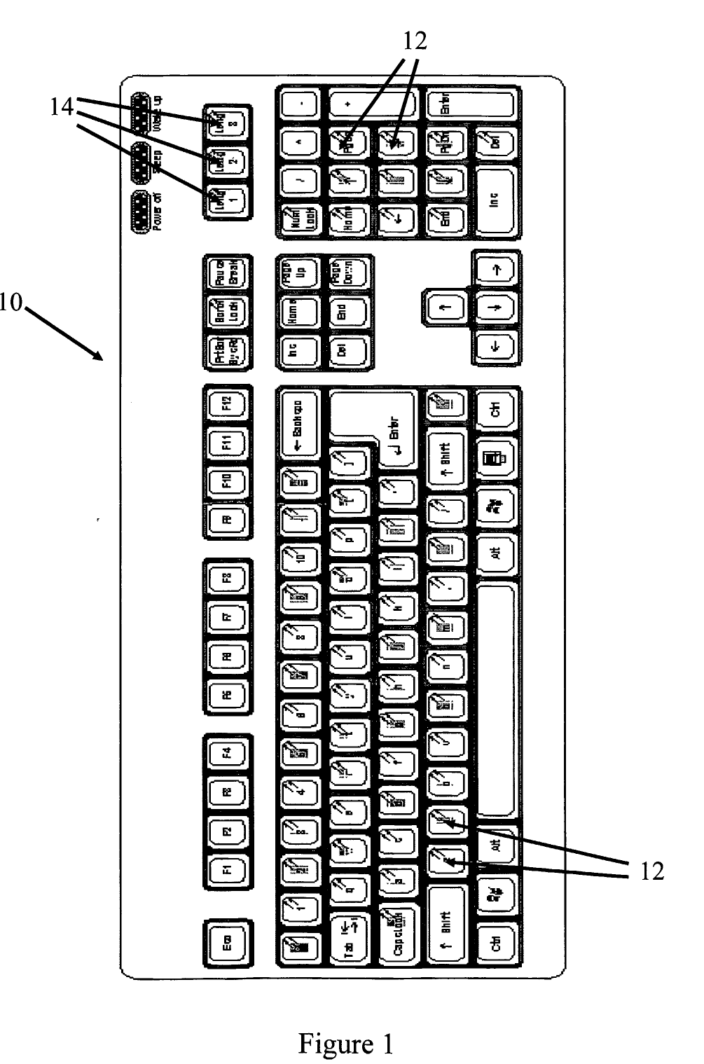

Reference is now made to FIG. 1 illustrating a multi-lingual keyboard in accordance with a preferred embodiment of the present invention, at a predetermined appearance. As can be seen, the appearance of keyboard 10 is very similar to the appearance of prior art English letter keyboards. Keyboard 10 is provided with a plurality of keys 12, each represents a letter of a predetermined language. The keys have sensory contacts beneath them (as will be comprehensively explained herein and a touch surface on top. 64 keys of plurality of keys 12 are changeable units having embedded indicators. Those keys are indicated by double arrows in their top right corner. The indicators indicate the letters in the language that is currently represented on the keyboard.

The dimensions of keyboard 10 (170×460×35), its geometry and keys layout conforms to the standard PC AT keyboard. However, three additional keys 14 indicated by Lang1, Lang2 and Lang3 are adapted for layout controlling. Keying one of those keys will result in a change of the appearance of keyboard 10 to an appearance in which another language is represented on the 64 keys of plurality of keys 12 that are indicated with double arrows. Additional regular buttons can be placed such as Num Lock, Caps Lock, Scroll Lock that are not needed for a multifunctional keyboard. It should be mentioned that the keyboard is not limited to three languages, the representation of the keys can be converted to any type of characters, signs, and others as mentioned herein.

It should be mentioned herein that the similarity of the multi-lingual keyboard of the present invention to a PC standard keyboard is given solely as an example that had been tested. However, any other type of input device can be employed with multifunctional keys as claimed in the present invention. This example, by no means, narrows the scope of the present invention.

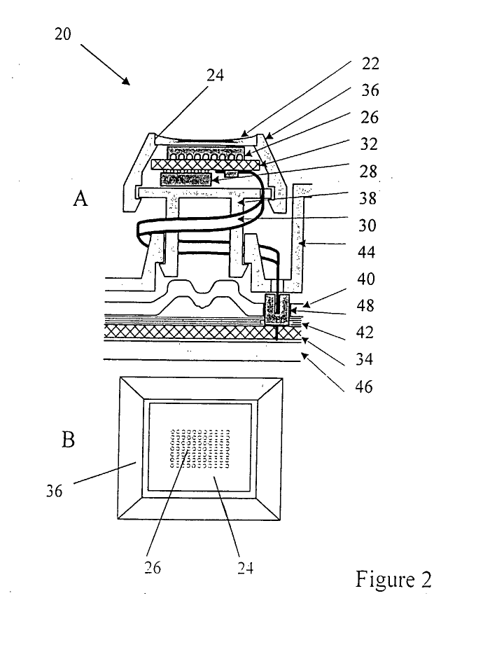

Reference is now made to FIG. 2a and FIG. 2b illustrating an upper and side views, respectively, of a key in a multi-lingual keyboard in accordance with a preferred embodiment of the present invention. Key 20 has dimensions that are substantially similar to regular key in a keyboard and is provided with a touch surface 22, which is the surface on which keying in is performed by the user so as to establish the appropriate electrical signal transferred to the computer's processor.

Touch surface 22 is provided on a transparent window 24 beneath which a display means is provided, preferably a LED matrix 26. LED matrix 26 is adapted to display a character on touch surface 22. It preferably consists of seven columns of LEDs with 11 LEDs in each column. Any other arrangement of the LED matrix can be employed such as matrices of 8*11 or any other arrangement. The number of LEDS lamp can vary with the demands of the signs that should be represented on the input device. The LED can consist of the lamp itself without any shields and isolations that are customary in the art since the desire is to bright only the upper surface of the key. Therefore, more lamps can be provided in the LED matrix.

Optionally, laser beam can be employed instead of LED matrix for displaying the signs as well as optical fibers, lighting via cold gas, LCD screen and any other technology or display means allowing representation of signs on touch surface of the key.

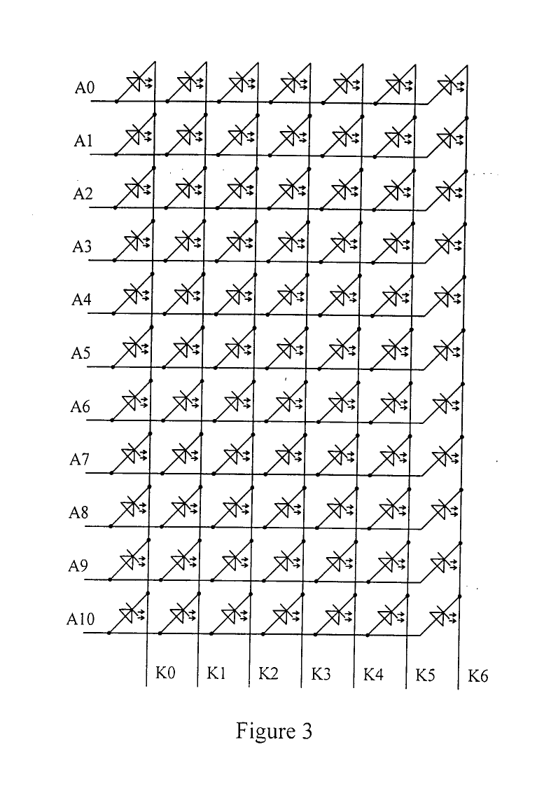

Reference is now made to FIG. 3 illustrating a circuit of a LED matrix in accordance with a preferred embodiment of the present invention. Anodes of LEDs are joins in rows, and cathodes—in columns.

Back to FIGS. 2a and b. A PCB 32 of the key is provided also beneath transparent window 24 and. A flexible cable 30 connects the PCB of each key with a keyboard board, PCB 34 through a connector 48. LED matrix 26 and PCB 32 are housed in a housing 36 that rests on a stem 38 of the key. Stem 38 is movable and is positioned as a default in an upward position. An elastomeric pad 40 is placed beneath key 20 wherein the pad is folded so as to uphold stem 38 in an upward position. When key 20 is keyed in, stem 38 is pushed downwardly against the force of elastomeric pad 40 and then it moves back upwardly due to the force of the pad. Film with sensory contacts 42 is placed under stem 38 wherein beneath each stem a specific sensory contact is provided so as to allow a signal to be generated when a key is keyed in. Sensory contacts 42 are secured and connected on PCB 34 of the keyboard.

Each key 20 is provided with a decorative panel 44 and all keys rests on a keyboard base 46.

The keys are designed so as to allow pressure force dependency of keying in the key in the push axis that is similar to keying in pressure of a key in a standard IBM PC keyboards. Tactile effect during pressing the key is due to the specific geometry of lugs on the elastomeric pad.

key's traveling distance—2÷4 mm

Force when starting pressure—2.2 N

Force during final pressure—less than 1 N

For keys with big surface area such as Space bar or Enter, the forces may be doubled. It should be mentioned that any other calculation of pressure can be employed in order to design the elastomeric pad beneath the keys and in no way limits the scope of the present invention.

For powering LED matrix 26, chip driver 28 in preferably multiplex mode outputs low voltage level to the cathodes shown in FIG. 3, by turn. To provide required brightness level of LED matrix 26, chip driver 28 maintains an average current of about 2 mA. Taking into account on-off time ratio, this current in a single pulse is substantially 14 mA. Chip driver 28 has to keep outgoing current to the matrix anodes that equals about 14 mA and incoming current from the matrix cathodes (when all LEDs in the column are enabled) at least 14×11=154 mA. When all LEDs of the indicator are enabled, average consumption current will be approximate 180 mA. Average key current on the keyboard at maximal brightness will be approximately 40 mA. Therefore, the driver power voltage should be substantially 2.5 or 3.3 V.

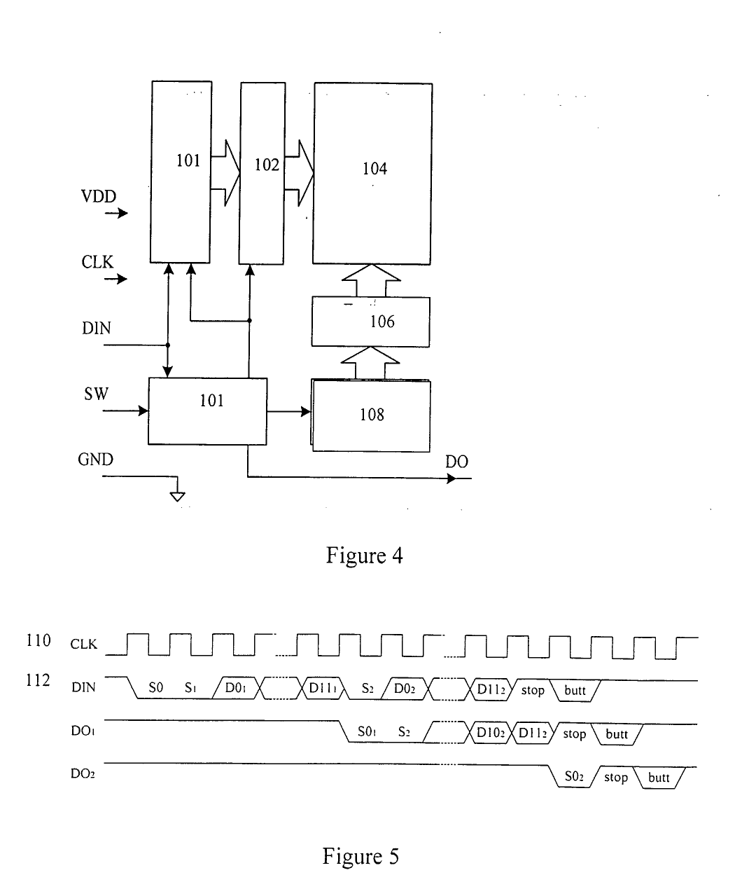

Reference is now made to FIG. 4 illustrating a schematic representation of the chip driver components in relation to the LED matrix in accordance with a preferred embodiment of the present invention. Signals are transferred through flexible cable 30 (shown in FIG. 2b) provided with 6 wires, as follows:
VDD—chip power voltage;
CLK—clock signal;
DIN—input data and control bit;
SW—input signal of normally open key contact;
GND—common wire of power, data and second signal contact;
DO—output data and control bit.

Input data in serial code are passed to an 11-digit shift register 100. When it is refilled, control circuit 101 permits current output from row drivers 102 to the anodes of one of the rows in LED matrix 104. Column selection in a column driver 106 is performed using 7-digit looped shift register 108. Any changes of currents being output to the LED matrix are performed only during data exchange session with external controller of the keys.

Reference is now made to FIG. 5 illustrating time diagrams of data exchange between a controller and two exemplary units in accordance with a preferred embodiment of the present invention. CLK cycles 110 with a constant frequency of about several megahertz are intended for synchronization purposes of an external controller and the keys. On the DIN bus 112, when no exchange is performed, logical 1 is set. In the beginning of the exchange session, the controller sets logical 0 level (bits S0 and S1) for 2 CLK cycles. Then, bits (D0-D10) follows, zero bits in which means enabling the corresponding LEDs in the currently selected matrix column. To avoid parasitic flashes of column LEDs, during filling shift register 100, control circuit 101 disables row drivers 102 until refilled (shown in FIG. 4).

Bit D11 is a sign of key synchronization. When it is in zero state, looped shift register 108 (FIG. 4) resets to state 1000000. In this state, current may run only through LEDs of the first column. In the beginning of next exchange session, looped shift register 108 will be set to 0100000 and the second column will be selected. After 7 exchange sessions, the entire matrix will be displayed. In order to lower brightness, “light” frames could be interleaved with “dark” frames, containing only “1” D0-D10 bits, while the controller keeps regularity and constant (150 Hz) refresh rate.

Output unit signal (DO) during filling of 11-digit looped shift registers is kept in a state in which all bits are set. When filling is completed, it is set for one clock cycle to a zero state (S01) and then with a delay of 1 clock cycles, it copies input signal DIN 112. Filling of the shift register with the following bits in the signal is not performed until a bit STOP is received. Such a solution allows connection of several sequentially connected keys to one output of a controller.

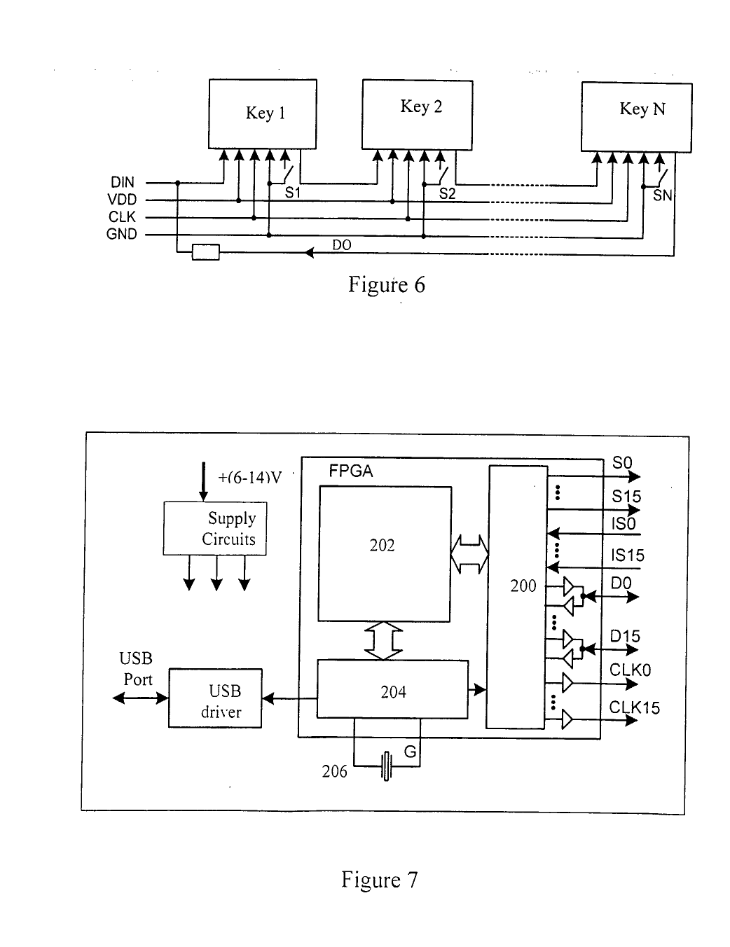

Reference is now made to FIG. 6 illustrating a circuit of connections to a plurality of keys in accordance with a preferred embodiment of the present invention. The sequential connection between the keys markedly simplifies the keyboard PCB routing and reduces the quantity of communication channels required for controlling the functionality of the keys in the keyboard.

The number of keys connected in a chain is limited by circuit capacity of the controller's outputs and lowering of the image refresh rate due to increased in the time of exchange session. This number of keys may be raised up to 16. This is the case in the keyboard that was designed as a prototype, However, more that 16 keys can be sequentially connected, but has to be adjusted in accordance with the demands of the keyboard in question.

DIN signal between information bits D0-D11 has zero separator bits Sn. When inserting “one”-bit in place of the separator (condition STOP), all keys of the chain are switched to the mode waiting for the next exchange session that begin with “double-zero” condition in the input information signal.

To simplify the PCB routing through keyboard's PCB 30 as shown in FIG. 2b, the signal that is transferred from the key's contact is passed through flexible cable 30 to chip driver 28 (the cable and the driver are shown in FIG. 2b) of the corresponding key (SW line) and is encoded to the output DO signal with a bit. Its zero state corresponds to a pressed key. Reception of “butt” bits from the output of the last key in the chain by the keyboard controller is possible using the DIN line (to reduce amount of interconnections). To exclude condition of simultaneous filling of this bit in all keys in the chain, the permission of its filling is given only to key currently receiving in current exchange session zero D11 bit—a synchronization bit.

In light of the information provided herein, timing parameters can be evaluated. Assuming there are 16 keys in a chain and the refresh rate is 150 Hz. The quantity of gray levels is 16. So, frequency of exchange sessions is calculated to be:
150×16×7=16800 Hz
During the single exchange session, the following number of bits is transferred:
16×13+3=211 bit
CLK frequency is to be greater than:
16800×211=3544800 Hz≈4 MHz.
The keyboard is provided with a controller whose tasks are as follows:

data exchange with USB host;

scanning key contact sensors;

providing regular exchange sessions with keys organized in chains;

storing and updating (preferably via USB interface) icons of keys;

storing and updating miscellaneous settings: brightness, flashing etc.

Reference is now made to FIG. 7 illustrating schematic representation of a controller in accordance with a preferred embodiment of the present invention. Refreshing of symbol images on the keys and querying its contact sensors are performed by multiplex exchange channel 200 with 16 key chains. All required information is stored in dual-port memory device 202. Through a second port of the device from the side of the computer, using the driver of the corresponding interface and control circuit, reading and writing of the data storage are performed

Synchronization of the controller 204 is made with the quartz resonator G 106 preferably with frequency of 16 MHz. All digital components of the controller with an exception of interface drivers are implemented on the programmable logic crystals of FPGA-type (“Spartan-2” or “Spartan-3” series are manufactured by XILINX company, for example).

The controller's dual-port memory size can be now estimated as follows: one or two (for upper and lower case) icons per key have to be kept in the memory. Total quantity of icons is:
64+58=122

Besides the icons, the following service information has to be stored in the memory:
flash flag—1 bit
brightness (on-off time ratio of display)—4 bits
flag of presence upper-case icon—1 bit
value of key sensor (whether key pressed or not)—1 bit
timer-counter of sensor state transition (to avoid bounce effects)—3 bits

With organization of memory in 16 bits per word, one icon can contain 7 addresses (7 columns of indication matrix) and additional word of service information—a total of 8 words. Taking into account that there have to be 2-4 sets of icons (languages), changed during normal operation (without waiting for icons reloaded from the computer), the total size of dual-port memory has to be up to 8 kBytes.

In addition, there is listed data of control parameters to be transferred from the control circuit to the multiplex channel:
topologic map of keys connection to the keyboard controller (what chains contain keys depending on the key number in the chain);
delay time before starting to repeat keying in events;
period of repeating events;
overall brightness of key displays;

receiving events concerning press and release events on the keyboard in reverse direction.

Totally—up to 32 addresses.

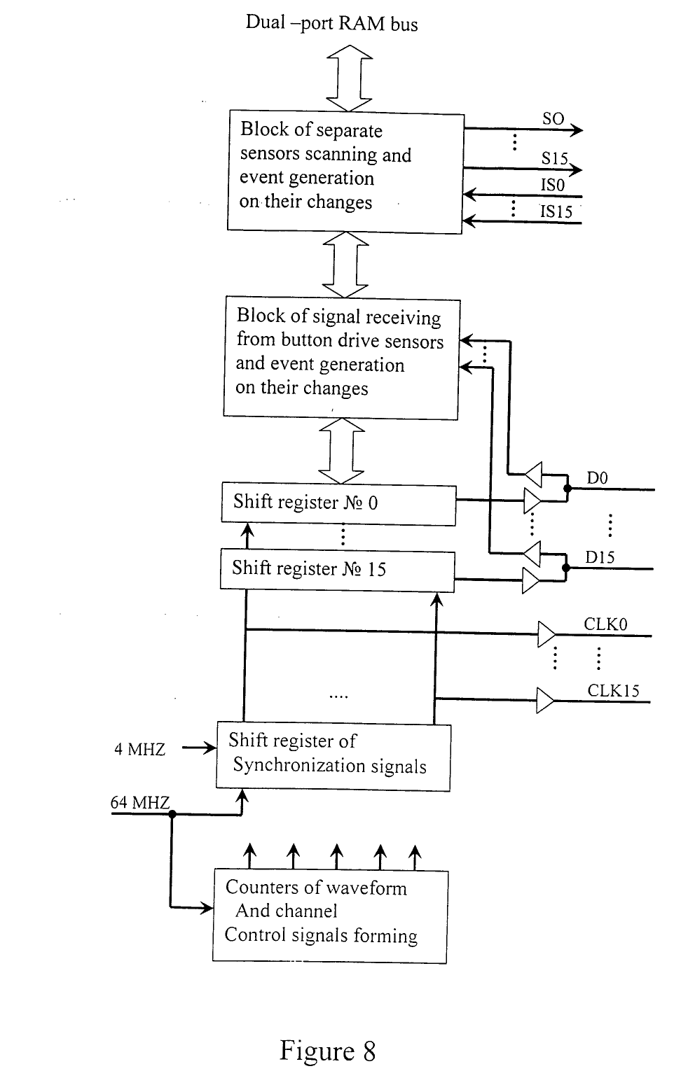

Reference is now made to FIG. 8 illustrating a schematic representation of the structure of multiplex channel of a keyboard controller in accordance with a preferred embodiment of the present invention. The main function of the illustrated block is regular cyclic refreshing of symbol images on the keys, querying state of contact sensors and preparing messages for the control circuit about changes occurring in them.

Multiplex channel loads 11-digit shift register of driver chips with reading words from dual-port RAM and sequentially loading its shift registers No 1-No 15 in corresponding order. These registers (one register per chain) work at CLK frequency, equal to about 4 MHz. Each chain forms its own phase of synchronization signal. It is preferably performed with shift register of synchronization signals working at frequency of substantially 64 MHz. One shift lasts for 13 periods of 64 MHz frequency. This solution allows spreading of pulse currents in the keyboard on time. It reduces levels of radio noises and helps memory device to exchange service information with other working registers of the control circuit with addressing frequencies that are multiplies of 64 MHz. Each of the 16 chains is served by RAM in 13 clock cycles periods of 64 MHz clock per one key in the chain. During this time, not only data fetch from RAM is performed, but also working with service information, stored in RAM, advancing counters, synchronization and address calculation for RAM access is performed.

Exchange session with keys in the single chain is divided preferably into three phases:
fetching service information about operation mode from the memory and checking what LEDs are to be lit in this session (for regulation of brightness and flash mode; if necessary—lighting is inhibited in the current session with forced resetting information bits in shift registers to the “1” state);
sequential fetching information for lighting columns of LEDs from the memory and writing it into shift register—16 accesses for 16 available keys in a chain;
receiving value of “butt” bit and its processing with purpose of event generation on state transition of the corresponding sensor.
   Total quantity of bit intervals in the session equals to:
   13×(1+16+1)=234.
   Frequency of exchange sessions:
   4 MHz/234=17 kHz

Information for columns being transferred to the keys of a single chain in the single exchange session corresponds to different numbers of columns in the matrices. It allows query on one contact sensor in every session. Table 2 depicts the number of displayed columns that are shown in dependency on key position in the chain (key number) and number of session in the indication frame.

Querying on contact sensor of a key is performed in case of displaying zero column and availability of information for displaying zero value of bit D11. These conditions are marked in the table with bold zeroes. In this table, one can see that for querying 16 keys in a chain, 16 exchange sessions suffice. In the entire refresh frame, the number of exchanges equals 7×17. Every key is queries 7 times per frame.

To raise “sharpness” of key contact sensor recognition, keyboard controlled processes 7 last “butt” bit values from each of the sensors before making a decision whether the key is keyed in or released. Effective rate of querying keys with such solution equals to the refresh rate of 150 Hz (it is possible to recognize up to 75 key clicks per second). Generating events to the control circuit about the keys state is performed after analyzing the following elements:
number according to the topographic map of keys, currently selected with zero synchronization bit D11;
presence of low “butt” signal in the chain;
previous value of contact sensor state in the service flag;
previous value of contact sensor state transition timer-counter.

Because of possible variations in number of keys in a specific implementation of the keyboard, service information reading of suitable words from topologic map is performed. Every key chain corresponds to a bit of presence (or absence) of the next key. “1” in the corresponding bit means that the key is present, and refilling of the shift register is performed. When it is “0”, only stop (i.e. high level) pulses are output to the corresponding chain.

Since not all keyboard keys can be or should be equipped with LED matrix and driver chip, it is possible in a specific implementation of a key in a multi-lingual keyboard, where contact sensors have their own scanning circuit independent of driver control circuits, to provide block scanning of separate sensors and event generation on their changes. This block using lines S0-S15 performs cyclic querying of sensors matrix, that can have up to 16 sensors per line—inputs IS0-IS15. Querying rate equals to 1 kHz and filtering of sensors signals is performed so as to avoid bounce effects. The block uses its own part of topologic map, which defines primary scan-codes for generating events to the control circuit. To avoid time coincidence of event generation from “scanning block” and “receiving block”, synchronization of these blocks is performed from the single counter of exchange sessions.

Addresses of RAM access are formed using counters, one of them counts “1” values in every session in words of topologic map. Values of this counter are serial numbers of keys and they are used for forming primary scan codes of contact sensors. Other counters count quantity of accesses to the memory for filling shift registers (count of chains is 16), quantity of shift pulses in exchange session (13 bit×16 units in chain), quantity of sessions for displaying all matrix columns (7), and quantity of exchange sessions in the brightness forming cycle (16).

In order to make more uniform distribution in time of currents consumed by LED matrices, lowering noises made by these currents, and lowering parasitic interference with lamps powered from AC, the start of the exchange sessions in the chains is performed with a shift in phase. Each following chain is shifted by 64 bit intervals referenced to the chain with less number. Additionally, interleaving of indicator lighting when regulating brightness is performed. One exchange frame consists of 7 exchange sessions (equal to count of columns in the indicators). The cycle of brightness regulation consists of 16 frames. If the indicators work at the full brightness, lighting is performed in all 16 frames of the cycle. If full brightness is not needed, not all frames are lit, but only part of them. To smooth summary current consumption by keyboard LEDs, all lit frames are arranged uniformly in the cycle. This is clearly shown in Table 2.

Starting a cycle for every indicator is different. For example, when the first key chain displays the first frame of brightness cycle, the second chain does the second frame and so on. To implement interleaving of columns in the exchange sessions, cycles and time shifting separate counters and digital delay lines are involved.

Control and synchronization circuit is intended for asynchronous communication between personal computer and multiplex exchange channel with keyboard keys using specialized USB driver chips and dual-port RAM. System clock 64 MHz for all components of FPGA is formed using frequency multiplier based on DLLs, included as part of FPGA crystal reference oscillator G. Control circuit consists of 8-digit microprocessor core such as a “PicoBlaze” with USB controlled and dual-port RAM connected. For storing commands and data, the microprocessor involves memory blocks of FPGA.

Software of microprocessor core is a program with USB interface functions and functions of interchange with control circuit of the keyboard. Microprocessor queries dual-port memory of FPGA about keys pressed, translates primary scan-codes of multiplex channel into standard keyboard scan codes, prepares USB packets and transmits information about keys pressed to the host.

The program is supported in different operation modes such as “boot mode” and “fully-functional mode”. In “boot mode”, the keyboard follows Boot Keyboard subclass of USB HID class to permit user control of the computer during computer boot. BIOS can work only with such “boot mode” keyboards.

After OS is loaded, special keyboard driver switches the keyboard into fully-functional mode that supports additional keys on the keyboard and special indication features. When the keyboard is powered, FPGA loads its memory with default hardcoded keyboard layout, typically “US International”. After turning the keyboard into fully-functional mode, the microprocessor begins to send USB frames with protocol defined in special HID descriptors. According to USB HID protocol, some keys (not modifier keys) must be transferred in relative mode, i.e. in each USB packet, only change events are transferred. Some of keys (modifiers—Alt, Ctrl, Shift) are transferred in absolute mode, i.e. in every USB packet states of all these keys are transferred. Press and release events of modifier keys are traces by standard USB keyboard driver comparing current and previous blocks provided by the keyboard.

As an example, the computer and the keyboard can be provided with userspace service for keyboard layout loading in Windows 98/NT/ME/2000/XP/2003. This is a userspace program that uses standard interfaces in Windows mechanism for accessing HID devices through special interface provided by hid.dll. The program has an ability to enumerate all attached HID devices, check their types, and exchange data with any of attached devices.

When the program finds that a keyboard of the present invention is connected, it loads it with current configuration of languages (this configuration is read from Windows Layout Manager) or from user-supplied configuration. Then, glyphs and icons are loaded from the corresponding files and are sent into the keyboard controller. The keyboard is configured for supporting several languages with simple bank switching, implemented in the keyboard hardware. When a user changes keyboard layout (with buttons Lang1, Lang2, Lang3 as shown in FIG. 1 or by using any other method of changing input language), Windows sends all windows special event notification about input language change. The program catches this event and commands the keyboard to switch the desired layout.

Glyphs for keys are edited in the special graphics editor application, and a user can draw symbols that exactly fit his specific requirements.

Glyph editor can create preliminary draft glyphs nearly in any language that can be typed from the keyboard automatically based on any of fonts available in the system. To do this, program queries Windows to translate virtual key codes (VK_Q, VK_W, VK_E and so on) to the corresponding Unicode character code in any language supported by Windows, that can be rendered into glyph for a key.

It is possible to provide third-party developers with an ability to control the keyboard and receive it events through specially written API, not requiring developers for studying internal keyboard structure or details of USB exchange protocol.

Many applications can be written for support non-standard icons, for example messages on buttons with hot keys, mathematical symbols or anything else.

To other circuits, it is preferable to provide third-party microassemblies of DC/DC converters. They convert primary voltage in range 12-24 V (from an external adapter) to stabilized voltages required for working of electronic circuits of keyboard. For supplies of LED matrix driver chips, a limitation is provided to avoid overloading when not-allowable level of lighting is reached.

Optionally, one can include photodiode sensor of lighting background for automatic adjustment of indication brightness, and automatic brightness lowering on current overloading.

For storing some standard icons and last settings of the keyboard it is possible to attach separate ROM chip to the FPGA.

It should be mentioned that any other technology can be employed in order to indicate the signs on the key. Examples can be an LCD screen such as in hand computers, digital watches etc. Optionally, the letters can be represented by a laser beam. Any other representation of signs on the keys is covered by the scope of the present invention.

Optionally, the indication of signed on the keys can be colored representation so that each language is also represented by a certain color so as to facilitate the user.

The multi-lingual keyboard of the present invention can be connected to a computer based on an actuating system such as windows, OS2, LINUX, UNIX, SOLARIS, or DOS.

It should be noted that the multifunctional key can be used in any input device such as keyboards of different computers such as a notepad, a phone, calculating machines, controllers, or any other device as well as a personal computer that serves as a remote control to control functions in a house such as air-condition, TV, stereo etc.

Another important application among the vast number of applications that can utilize the multifunctional key of the present invention is in the security field wherein in devices such as safe where a user insert a combination of numbers, each key can receive more than one sign or letter hence multiplying the possibility of combinations.

It is important to notice that the multilingual keyboard is a universal keyboard in the sense of the signs represented on the keys. For example, the keyboard may be used for children; hence representing animals, or educational signs; it may be adapted for musical instruments such as an organ; hence represented by musical notes, chemical structures and formulas, computer language as well as machinery. All the signs may be represented on a single keyboard or keypad or represented on a dedicated keyboard. It will be is possible also to purchase a software that will allow certain unique signs to be represented on an existing keyboard.

It should be mentioned that the representation of the signs on the keys can be supported and controlled by a software by which the signs can be changed or their places can be modified to the demands of the user without limiting the user to the standard arrangement of keyboards.

The multifunctional key can interact with any software that is displayed on a computer. For example, if a game is displayed, the functions in the game such as jump, double jump or boxing can be displayed on the multifunctional keys. Another example can be in programming software, where the functions of the software are displayed directly on the computer's monitor due to programming of the multifunctional keys to receive a predetermined function instead of a sign.

Using multifunctional keys enables the user to use a universal input device as a calculator of a predetermined function or a lingual dictionary without the need to use different calculator for each function. In a similar manner, a universal remote control can be manufactured by using multifunctional keys to interact with different devices or systems, each of which interacts with the specific function that is displayed on the specific key in a certain moment.

In another application, the multifunctional key can be used in GPS devices in the vehicle industry in which the keys can be used for several functions instead of only one.

As can be seen, the multifunctional key and the multifunctional keyboard technology can be applied onto numerous applications, and actually in any case a key is used in an input or output deice.

It should be clear that the description of the embodiments and attached Figures set forth in this specification serves only for a better understanding of the invention, without limiting its scope as covered by the following Claims.

It should also be clear that a person skilled in the art, after reading the present specification can make adjustments or amendments to the attached Figures and above described embodiments that would still be covered by the following Claims.

TABLE 1

| Exchange | | | | | | | | | | | | | | | | |
|---|---|---|---|---|---|---|---|---|---|---|---|---|---|---|---|---|
| session | Unit number in the chain | | | | | | | | | | | | | | | |
| number | 1 | 2 | 3 | 4 | 5 | 6 | 7 | 8 | 9 | 10 | 11 | 12 | 13 | 14 | 15 | 16 |
| 1 | 0 | 1 | 2 | 3 | 4 | 5 | 6 | 0 | 1 | 2 | 3 | 4 | 5 | 6 | 0 | 1 |
| 2 | 6 | 0 | 1 | 2 | 3 | 4 | 5 | 6 | 0 | 1 | 2 | 3 | 4 | 5 | 6 | 0 |
| 3 | 5 | 6 | 0 | 1 | 2 | 3 | 4 | 5 | 6 | 0 | 1 | 2 | 3 | 4 | 5 | 6 |
| . . . | | | | | | | | | | | | | | | | |
| 7 | 1 | 2 | 3 | 4 | 5 | 6 | 0 | 1 | 2 | 3 | 4 | 5 | 6 | 0 | 1 | 2 |
| 8 | 0 | 1 | 2 | 3 | 4 | 5 | 6 | 0 | 1 | 2 | 3 | 4 | 5 | 6 | 0 | 1 |
| . . . | | | | | | | | | | | | | | | | |
| 14 | 1 | 2 | 3 | 4 | 5 | 6 | 0 | 1 | 2 | 3 | 4 | 5 | 6 | 0 | 1 | 2 |
| 15 | 0 | 1 | 2 | 3 | 4 | 5 | 6 | 0 | 1 | 2 | 3 | 4 | 5 | 6 | 0 | 1 |
| 16 | 6 | 0 | 1 | 2 | 3 | 4 | 5 | 6 | 0 | 1 | 2 | 3 | 4 | 5 | 6 | 0 |

TABLE 2

| Brightness | Number of frame in the cycle | | | | | | | | | | | | | | | |
|---|---|---|---|---|---|---|---|---|---|---|---|---|---|---|---|---|
| level | 1 | 2 | 3 | 4 | 5 | 6 | 7 | 8 | 9 | 10 | 11 | 12 | 13 | 14 | 15 | 16 |
| 0 | + | | | | | | | | | | | | | | | |
| 1 | + | | | | | | | | + | | | | | | | |
| 2 | + | | | | | + | | | | | + | | | | | |
| 3 | + | | | | + | | | | + | | | | + | | | |
| 4 | + | | | + | | | | + | | | + | | | + | | |
| 5 | + | | | + | | + | | | + | | | + | | + | | |
| 6 | + | | + | | + | | + | | | + | | + | | + | | |
| 7 | + | | + | | + | | + | | + | | + | | + | | + | |
| 8 | + | | + | | + | | + | + | | + | | + | | + | | + |
| 9 | + | + | | + | | + | + | | + | + | | + | | + | + | |
| 10 | + | + | | + | + | | + | + | | + | + | | + | + | | + |
| 11 | + | + | + | | + | + | + | | + | + | + | | + | + | + | |
| 12 | + | + | + | + | | + | + | + | + | + | | + | + | + | + | |
| 13 | + | + | + | + | + | + | + | | + | + | + | + | + | + | + | |
| 14 | + | + | + | + | + | + | + | + | + | + | + | + | + | + | + | |
| 15 | + | + | + | + | + | + | + | + | + | + | + | + | + | + | + | + |

1. A multifunctional keyboard comprising a plurality of multifunctional keys having selectable key functions, at least some of the keys each including:
a touch surface;
an LED matrix adjacent to said touch surface and being operative to display selectable visual indications corresponding to said selectable key functions.

2-20. (canceled)

21. A multifunctional keyboard according to claim 1 and wherein at least some of the keys each include a driver chip driving said LED matrix and a connecting cable providing communication between said key and an external device.

22. A multifunctional keyboard according to claim 21, wherein said connecting cable is provided with at least 6 conductors including a VDD—chip power voltage conductor; a CLK—clock signal conductor; a DIN input data and control bit connector; an SW—input signal of normally open key contact conductor; a GND—common wire of power, data and second signal contact conductor; and a DO—output data and control bit conductor.

23. A multifunctional keyboard according to claim 1, said LED matrix comprises 7 columns and 11 rows of LEDs.

24. A multifunctional keyboard according to claim 21, wherein said driver chip comprises: an 11-digit shift register adapted to receive input data in serial code; row drivers connected to anodes provided in rows in said LED matrix; control circuit adapted to permit current output from said row drivers; a column driver adapted to select the column of said LED matrix using a 7-digit looped shift register.

25. A multifunctional keyboard according to claim 21 and also comprising an elastomeric pad having a plurality of sensory contacts, said elastomeric pad being located beneath said plurality of multifunctional keys and being operative to normally retain said plurality of multifunctional keys in an upward position so as to prevent contact with said sensory contacts when the multifunctional key is in said upward position and to allow contact when one of said plurality of multifunctional keys is depressed.

26. A multifunctional keyboard according to claim 1 coupled with at least one of gaming device, a computer and an internet communicator.

27. A multifunctional keyboard according to claim 1 and wherein said selectable key functions are multi-lingual key functions.

28. A multifunctional keyboard according to claim 1 and wherein said selectable key functions are user programmable.

29. A multifunctional keyboard according to claim I and wherein said selectable visual indications are free-form programmable.

30. A multifunctional keyboard according to claim 22, wherein said driver chip comprises: an 11-digit shift register adapted to receive input data in serial code; row drivers connected to anodes provided in rows in said LED matrix; control circuit adapted to permit current output from said row drivers; a column driver adapted to select the column of said LED matrix using a 7-digit looped shift register.

31. A multifunctional keyboard according to claim 22 and also comprising an elastomeric pad having a plurality of sensory contacts, said elastomeric pad being located beneath said plurality of multifunctional keys and being operative to normally retain said plurality of multifunctional keys in an upward position so as to prevent contact with said sensory contacts when the multifunctional key is in said upward position and to allow contact when one of said plurality of multifunctional keys is depressed.

32. A multifunctional keyboard according to claim 30 and also comprising an elastomeric pad having a plurality of sensory contacts, said elastomeric pad being located beneath said plurality of multifunctional keys and being operative to normally retain said plurality of multifunctional keys in an upward position so as to prevent contact with said sensory contacts when the multifunctional key is in said upward position and to allow contact when one of said plurality of multifunctional keys is depressed.

33. A multifunctional keyboard according to claim 30 and wherein said selectable key functions are user programmable.

34. A multifunctional keyboard according to claim 30 and wherein said selectable visual indications are free-form programmable.

35. A multifunctional keyboard according to claim 32 and wherein said selectable key functions are user programmable.

36. A multifunctional keyboard according to claim 32 and wherein said selectable visual indications are free-form programmable.

37. A method of operating a multifunctional keyboard comprising:
providing a plurality of multifunctional keys having selectable key functions, at least some of the keys each including:
a touch surface; and
an LED matrix adjacent to said touch surface and being operative to display selectable visual indications corresponding to said selectable key functions;
programming said selectable key functions; and
programming said selectable visual indications corresponding to said selectable key functions.

38. A method of operating a multifunctional keyboard according to claim 37 and wherein said selectable key functions are multi-lingual key functions.

39. A method of operating a multifunctional keyboard according to claim 37 and wherein said programming said selectable visual indications is free-form programming.

40. A method of operating a multifunctional keyboard according to claim 38 and wherein said programming said selectable visual indications is free-form programming.
